(19) United States
(12) Patent Application Publication
(10) Pub. No.: US 2006/0060169 A1
(43) Pub. Date: Mar. 23, 2006

(54) Fuel tank for a vehicle

(76) Inventor: Adam Leslie, Chatham (CA)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/945,089

(22) Filed: Sep. 21, 2004

(51) Int. Cl. F02M 37/00; B65D 6/00

(52) U.S. Cl. 123/510; 220/4.14

(57) ABSTRACT

A tank, such as for a volatile fuel, includes an inlet, an outlet and a hollow body. Liquid volatile fuel is admitted to the hollow body through the inlet, and is dispensed from the hollow body through the outlet, which is spaced from the inlet. The hollow body includes first and second layers. The first layer may be susceptible to permeation by vaporized volatile fuel, and the second layer, which is impermeable by vaporized volatile fuel, includes metal.

### FIELD OF THE INVENTION

Vehicles carry on-board a supply of fuel that is stored in a container. For example, automotive vehicles that use an internal combustion engine for propulsion carry a supply of fuel, e.g., gasoline, in a fuel tank.

### BACKGROUND OF THE INVENTION

The amount of hydrocarbons emitted from a vehicle is restricted to levels prescribed by governmental entities such as the Environmental Protection Agency and the California Air Resources Board. There are typically three sources of hydrocarbon emission associated with vehicles: hydrocarbons that are expelled via the exhaust system of the internal combustion engine, hydrocarbons that are spilled in the course of refueling the vehicle, and hydrocarbons that leak from the various components and connections associated with the fuel storage and delivery system on-board the vehicle. It is preferable to reduce or eliminate the emission of hydrocarbons from all of these sources.

It is also preferable to maximize as much as possible the operating and packaging efficiency of a vehicle. Thus, it is desirable to be able to reduce weight and to utilize the available spaces, regardless of shape, for fluid containers. Further, it is preferable to position the fluid containers in the available spaces around the vehicle so as to enhance the weight distribution.

It is believed that known fuel tanks are constructed with multi-layer plastic moldings, with metal stampings, or with resin impregnated wound fibers. It is believed that the known plastic fuel tanks, while readily moldable to fit unusual shaped spaces, are expensive to manufacture due to the use of materials that are necessarily impermeable to fuel vapor. It is also believed that known metal fuel tanks, while impermeable to fuel vapor, may in certain situations be unable to be manufactured in complex shapes. As to the fuel tanks constructed by winding fibers, it is believed that a critical feature of these tanks is their symmetrical construction for the purpose of containing highly pressurized fluids.

Thus, it would be advantageous to provide a fuel tank that can be formed into complex shapes and is impermeable to fuel vapor.

### SUMMARY OF THE INVENTION

The present invention provides a tank, which may contain a volatile fuel that vaporizes from a liquid, and includes an inlet, an outlet and a hollow body. Liquid volatile fuel is admitted to the hollow body through the inlet, and is dispensed from the hollow body through the outlet, which is spaced from the inlet. The hollow body includes first and second layers. The first layer is susceptible to permeation by vaporized volatile fuel, and the second layer, which is impermeable by vaporized volatile fuel, includes metal.

The present invention also provides a container that includes a shell having an interior surface and includes means for covering the interior surface. The shell defines a storage compartment and is asymmetrical. The means for covering the interior surface prevents permeation of the shell by contents of the storage compartment. Preferably, the means for covering includes applying a metal coating to the interior surface. And it is preferable that the metal coating includes aluminum, brass, bronze, copper, iron, nickel-silver, stainless steel or zinc. The metal provides a means for preventing permeation of the shell by the storage container's contents, e.g., a volatile fuel such as gasoline.

The present invention also provides a fuel system for a vehicle that has an internal combustion engine. The fuel system includes a filler neck, a tank, and a line that couples the tank to the internal combustion engine. Fuel is admitted to the tank via the fuel filler neck, and is dispensed from the hollow body. The hollow body includes a first layer that is susceptible to permeation by vaporized fuel, and a second layer, which is impermeable by vaporized fuel, that includes metal. The line delivers to the internal combustion engine fuel that is dispensed from the tank.

The present invention also provides a method of manufacturing a fluid tank. The method includes forming a plastic shell so as to define an interior surface, and covering the interior surface with a layer of metal.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention.

FIG. 1 is schematic view of a fuel system according to a preferred embodiment.

FIG. 2 is an enlarged cross-section taken along line II-II in FIG. 1.

### DETAILED DESCRIPTION OF THE PREFERRED EMBODIMENT

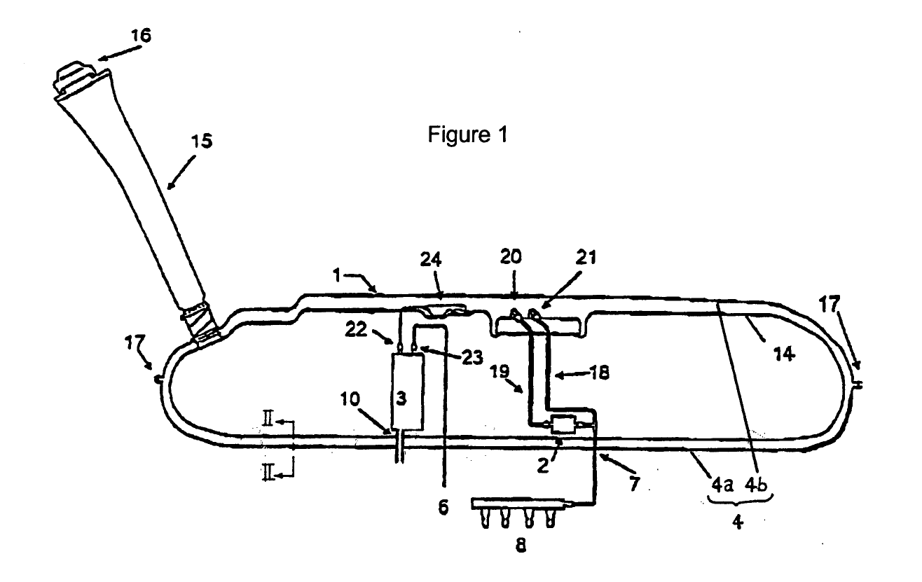

FIG. 1 shows a tank 1 fitted with an inlet, e.g., a filler neck 15, and a cap 16. A fuel line 19 leaves via a first connector 20, which is fixed to and communicates with the internal volume of the tank 1, and arrives at the inlet of a fuel pump 2. A return pipe 18 for returning excess fuel connects the outlet of the fuel pump 2 to a second connector 21, which is also fixed to and in fluid communication with the internal volume of the tank 1. A fuel pipe 7 also connects the outlet of the fuel pump 2 to one or more fuel injectors 8 of an internal combustion engine (not shown).

A vent valve 24 on top of the tank 1 is in fluid communication with a canister 3 via a connector 22. The canister 3, which may be attached to or spaced from the outside of the tank 1, may contain granulated activated carbon. A purging line 6 connects, via another connector 23, the canister 3 to an air intake of the internal combustion engine (not shown). A third connector 10 carried by the canister 3 enables the ambient environment external to the canister 3 to be connected with its internal atmosphere. A non-return valve may be placed in the connector 10 to prevent any passage from inside of the canister 3 to the ambient environment.

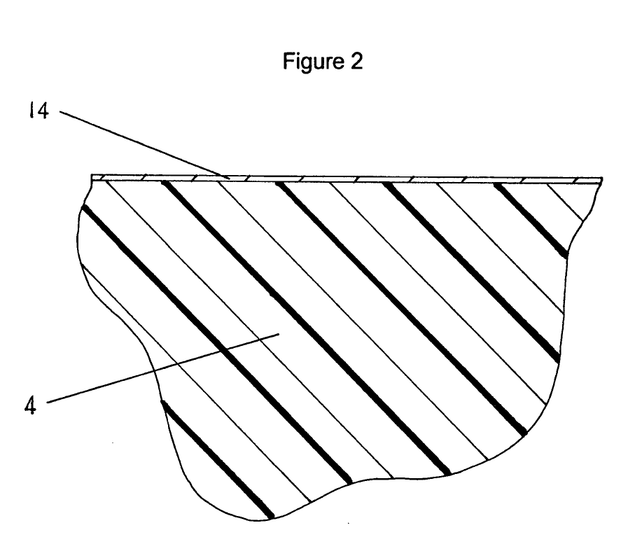

Referring additionally to FIG. 2, a preferred embodiment of the fuel tank 1 includes a laminated construction including a first layer 4 and a second layer 14. The first layer 4, which is shown as the exterior layer, provides a structural member 4 that may be assembled from a plurality of parts—two parts 4a and 4b are illustrated in FIG. 1. The parts 4a,4b are joined at coupling 17 in order to define an interior volume of the tank 1. The parts 4a,4b may be separately formed such as by injection molding, blow molding, casting, and thermosetting techniques. The coupling 17 may be made by means of chemical bonding, heat welding, adhering, etc.

The first layer 4 is preferably made of plastic. Examples of suitable plastics include high-density polyethylene, low-density polyethylene, polyvinyl chloride, polypropylene, polystyrene, acrylonitrile butadiene styrene, polymethyl methacrylate, polyethylene terephthalate, polyesters, silicones, urethanes and epoxies.

The first layer 4 may be formed in any shape or size that is desired to accommodate a given available space on a vehicle. In particular, the shape and size may advantageously be configured to facilitate positioning of the tank 1 in a desired location on the vehicle. An asymmetrical shape is likely to accommodate the given available space.

The second layer 14 is preferably made of metal that is impermeable to the fuel that is to be contained in the tank 1. Because the fuel may be volatile, i.e., evaporating from a liquid state, the second layer 14 is preferably impermeable to both the liquid and gaseous states of the fuel. Secondary layer 14 provides a means for preventing permeation of the shell by contents of the storage compartment.

Preferably, the second layer 14 is aluminum, brass, bronze, copper, iron, nickel-silver, stainless steel or zinc, or an alloy including one or more of these metals. Other metals that are impermeable to the fuel contained in the tank 1 are also possible.

The second layer is preferably applied to the first layer as a thin coating. The second layer may be applied by sputtering techniques, spraying, chemical depositing, or exposing the interior surface to a vaporized metal in a vacuum chamber. Other methods that produce a thin metal coating for the second layer 14 are also possible.

The second layer 14 is relatively thin, e.g., having a thickness no more than half that of the first layer 4 to which the second layer is applied. Preferably, the first layer 4 is at least ten times thicker than the first layer 4 to which it is applied and, more preferably, is at least 100 times thicker than the first layer 4 to which it is applied.

It is envisioned that other preferred embodiments could include constructing the tank 1 from more than two layers, and include metalizing the exterior surface of the first layer 4 in lieu of or in addition to metalizing the interior surface of the first layer 4.

Advantages of the present invention include that the structural member of the tank 1 is formed into almost any suitable configuration using known plastic manufacturing techniques, that the metal applied to the tank need only be thick enough to prevent migration of the contained fluid through the wall(s) of the tank 1, that the use of a minimal amount of metal reduces weight and cost, that the metal is applied using know coating techniques, that the manufacturing tooling is simplified, and the cost advantage of plastic materials is maintained.

The advantages of the present invention may include being implemented in many types of vehicles including cars, trucks, buses, motorcycles, boats, all-terrain vehicles, snowmobiles, personal watercraft and aircraft. The present invention may also be implemented in the fuel tanks of small engine powered devices such as lawnmowers, flexible-line trimmers, blowers, etc. Or the present invention may be implemented as a stand-alone fuel tank, e.g., for refueling a vehicle or small engine powered device.

While the present invention has been disclosed with reference to certain preferred embodiments, numerous modifications, alterations, and changes to the described embodiments are possible without departing from the sphere and scope of the present invention, as defined in the appended-claims. Accordingly, it is intended that the present invention not be limited to the described embodiments, but that it have the full scope defined by the language of the following claims, and equivalents thereof.

1. A tank for containing a volatile fuel that vaporizes from a liquid, the tank comprising:
an inlet through which liquid volatile fuel is admitted;
an outlet through which liquid volatile fuel is dispensed, the outlet being spaced from the inlet; and
a hollow body into which liquid volatile fuel is admitted via the inlet and from which liquid volatile fuel is dispensed via the outlet, the hollow body consisting of:
a first layer that is susceptible to permeation by vaporized volatile fuel; and
a second layer that is impermeable by vaporized volatile fuel, the second layer consisting of a uniform metal.

2. The tank according to claim 1, wherein the inlet comprises a filler neck through which liquid volatile fuel is gravity fed to the hollow body.

3. The tank according to claim 2, wherein the outlet comprises a fuel line through which liquid volatile fuel is pumped from the hollow body.

4. The tank according to claim 1, wherein the hollow body comprises exterior and interior surfaces, the first layer defines the exterior surface and the second layer defines the interior surface.

5. The tank according to claim 1, wherein the first layer comprises plastic.

6. The tank according to claim 5, wherein the first layer comprises at least one of high-density polyethylene, low-density polyethylene, polyvinyl chloride, polypropylene, polystyrene, acrylonitrile butadiene styrene, polymethyl metacrylate, polyethylene terephthalate, polyesters, silicones, urethanes and epoxies.

7. The tank according to claim 1, wherein the second layer comprises at least one of aluminum, brass, bronze, copper, iron, nickel-silver, stainless steel and zinc.

8. The tank according to claim 1, wherein the first layer is at least twice as thick as the second layer.

9. The tank according to claim 8, wherein the first layer is at least ten times thicker than the second layer.

10. The tank according to claim 9, wherein the first layer is at least one hundred times thicker than the second layer.

11-19. (canceled)

20. A fuel system for a vehicle having an internal combustion engine, the fuel system comprising:
a filler neck;
a tank into which fuel is admitted via the fuel filler neck and from which fuel is dispensed, the hollow body consisting of:
a first layer that is susceptible to permeation by vaporized fuel; and
a second layer that is impermeable by vaporized fuel, the second layer consisting of a uniform metal; and
a line coupling the tank to the internal combustion engine, the line delivering fuel dispensed from the tank.

21. The fuel system according to claim 20, further comprising:
a cap occluding the filler neck, the cap preventing refueling of the tank.

22. The fuel system according to claim 20, further comprising:
a pump pressurizing the line, the pump withdrawing fuel from the tank.

23. The fuel system according to claim 22, further comprising:
at least one fuel injector in fluid communication with the line, the fuel injector metering pressurized fuel to the internal combustion engine.

24. A method of manufacturing a fluid tank, the method comprising:
forming a plastic shell so as to define an interior surface; and
covering the interior surface with a layer of uniform metal.

25. The method according to claim 24, wherein the forming comprises separately molding first and second portions of the plastic shell, and coupling together the first and second portions of the plastic shell.

26. The method according to claim 25, wherein the molding comprises at least one of injection molding, blow molding, casting, and thermosetting.

27. The method according to claim 24, wherein the covering comprises at least one of sputtering, spraying, chemical depositing, and exposing the interior surface to a vaporized metal in a vacuum chamber.
